(19) United States
(12) Patent Application Publication
(10) Pub. No.: US 2017/0169291 A1
(43) Pub. Date: Jun. 15, 2017

(54) Method for the Automated Creation of a Data Set Characterizing a Technical Drawing

(71) Applicant: Siemens Aktiengesellschaft, Muenchen (DE)

(72) Inventors: Harald HELD, Bockhorn (DE); Hermann Georg MAYER, Prien am Chiemsee (DE); Efrossini TSOUCHNIKA, Muenchen (DE); Klaus WENDELBERGER, St. Leon-Rot (DE)

(73) Assignee: Siemens Aktiengesellschaft, Muenchen (DE)

(21) Appl. No.: 15/306,726

(22) PCT Filed: Apr. 21, 2015
(86) PCT No.: PCT/EP2015/058560

§ 371 Date: Dec. 12, 2016

(30) Foreign Application Priority Data
Apr. 25, 2014 (DE) 10 2014 207 874.1

(51) Int. Cl. G06K 9/00; G06F 17/50

(52) U.S. Cl. CPC G06K 9/00476; G06F 17/509; G06F 2217/74

(57) ABSTRACT

A method for automatically creating a data set, which characterizes a technical drawing having symbols and lines connecting the symbols, from the technical drawing.

### CROSS-REFERENCE TO RELATED APPLICATIONS

This is a U.S. national stage of application No. PCT/EP2015/058560 filed 21 Apr. 2015. Priority is claimed on German Application No. 10 2014 207 874.1 filed 25 Apr. 2014, the content of which is incorporated herein by reference in its entirety.

### BACKGROUND OF THE INVENTION

1. Field of the Invention

The invention relates to a method for automatically creating a data set characterizing a technical drawing having symbols and lines connecting the symbols, from the drawing.

2. Description of the Related Art

The description of complex associations and processes in technical systems and equipment can be represented in many cases and uses by technical drawings or diagrams. Drawings of this type are to be found, inter alia, in function charts for the description and creation of automation functions, such as are described in WO 2013/092654 A1. Typical properties of such drawings are that there are particular symbols which are linked to one another by lines.

Due to the scope of the documents to be processed and the error-proneness of manual processing, significant time and cost savings can be expected from an automated, digitalized method for the processing of drawings. Today, scanning and vectorization of diagrams in a sufficiently high quality, including text recognition (OCR) is possible without difficulty. For this purpose, the diagrams are scanned so that they are present as raster graphics and are converted using modern software tools into vector information and text.

Starting from this vector information (following optional pre-processing) symbol candidates can be filtered out from all the lines (e.g., using rules or searches for rectangles; see e.g. Y. Yu, A. Samal, S. C. Seth: A System for Recognizing a Large Class of Engineering Drawings. IEEE Trans on PAMI19:8, 868-890 (1997) and S. Adam, J. M. Ogier, C. Cariou, R. Mullot, J. Labiche, J. Gardes: Symbol and character recognition: application to engineering drawings. IJDAR 3, 89-101 (2000)) and connecting lines between the symbol candidates can be identified. Subsequently, in this way, a representation is obtained as a graph (in the mathematical sense) which describes the symbols and their connections to one another, specifically for each processed page. This graph, the node of which describes the symbols, forms a data set that can be used for further processing. The lines between the symbols are stored in the data set as connections with end points, where the end points are associated with the respective nodes that are connected by the line.

Using the previously created symbol library, the symbol candidates are then classified, i.e., associated with symbol types stored in the library. For this purpose, corresponding symbol data, in particular graphical identification features, of each symbol are stored in the symbol library. At this point, the recognition and interpretation are essentially concluded. It is further known to also perform a manual post-processing that serves for the correction of errors in the classification, i.e., the association of symbol types with the respective nodes.

A disadvantage in the conventional methods, however, is that although the problem of the computer-internal representation of the documents is solved, associations between documents and meta-information remain unconsidered. Particularly in the use described in WO 2013/092654 A1, it is the recognition and replacement of particular partial structures that is concerned. This requires not only the mere recognition of symbols and connections for the purpose of digitization, but also their semantic interpretation. If such information is required in a particular application, conventionally it must be input manually, which is very time-consuming and also fault-prone.

### SUMMARY OF THE INVENTION

It is therefore an object of the invention to provide a method with which semantic information and relationships can be extracted automatically from vectorized data of a technical drawing and is thus available for further processing.

This and other objects and advantages are achieved in accordance with the invention by a method of a) scanning the technical drawing, b) identifying the symbols in the technical drawing and storing nodes representing each symbol in the data set, c) identifying lines, each connecting at least two symbols in the technical drawing and storing connections representing each line in the data set, at least two end points being associated with each connection and one of the nodes which represent the symbols connected by the respective line being associated with each end point, d) providing a symbol library having a plurality of symbol types and symbol data associated with each symbol type, and e) associating exactly one symbol type from the symbol library with each node at least on the basis of the symbol data and storing the associated symbol type for the respective node in the data set, where step d) comprises storing a plurality of junction points with junction point data associated with each junction point for a number of the symbol types in the symbol library, and step e) comprises associating precisely one respective junction point with a number of the end points at least based on the junction point data and the storing the respective associated junction point for the respective end point in the data set.

The invention proceeds from the consideration that, although the problem of digitally recording existing documents that describe particular processes and associations in diagram form is already solved with known approaches, many actually semantically available and interpretable items of information remain unconsidered by the methods described in the prior art. In particular, although the connections or their arrangement between the individual symbols are detected, their semantic significance is not. A start should therefore be made precisely with the classification and the tracing of connections. This can be achieved, in particular, in that as early as during the creation of the symbol library, additional information is given, i.e., not only the information as to which symbol is concerned and how it can be recognized, but also further information items that relate to the possible junction points of the symbols or the components, method steps or similar, which are represented by the symbol. For each symbol, therefore, junction points are defined for which, for example, identifying junction point data are stored. The association of the located connections or their end points to the symbols is then further specified as follows: the end points are associated not only with the respective node, but with a particular junction point of the respective node or symbol. In this way, with the storage of corresponding information items in the junction point data in the symbol library, it can also be determined from the data set which connections carry which information or meaning. The data set thus also contains semantic information items that can be used during the subsequent further processing. Furthermore, the junction point data and the junction points form further information items that can be used during the determination of the correct symbol type for a symbol and thereby improve the accuracy of the recognition.

In an advantageous embodiment, the junction point data comprises a junction point type. Depending on the use, it can be indicated here whether a junction point is an entry or an exit, i.e., permits an incoming or an outgoing connection. More generally, a junction point type could also be stored which allows only one directed connection. A further junction point type is, for example, a negation. Combinations of junction point types are also herein conceivable, i.e., a plurality of types are assigned to one junction point. Further advantageously stored herein, for each junction point type, is with which junction point types the respective junction point type can form common end points of a connection. For example, for the connection type “entry”, it could be stored that, in a connection with one end point of which it is associated, the other end point must be associated with an exit. These information items can also be used in the recognition of the symbol types and thus enable a better and more accurate association.

For each of the different junction point types, identification properties are also advantageously stored in the symbol library. This serves to associate the respective end points of the found connections to the correct junction points during the classification of the nodes. For this purpose, for each junction point type, if required also specifically for each symbol type in the library, at least one property is defined, on the basis of which the junction point type can be identified. Depending on the use, this can be, for example, the identification based on the position of the respective connection in relation to a reference point of the symbolic representation, for example, relative to the top left corner of the corresponding envelope surface (bounding box) of the symbol. Alternatively or additionally, the junction point type can also be identified based on a text within a rectangle to be defined relative to the junction point position.

In a further advantageous embodiment of the method, the junction point data contains information that indicates whether the respective junction point must be associated with an end point. This information can also be used for the recognition of the symbol types, i.e., in the classification of the nodes in that specifically the symbol type selected from the library is associated with a node when and only when the junction point is found through the aforementioned information and is also connected.

The aforementioned step e), specifically the association of the junction points of the symbols with the end points of the connections, advantageously occurs serially, starting from a connection by tracing further connections adjoining the node of an end point of the connection. This means that the classification occurs successively along the connecting lines, which are continuously further traced. This enables the pre-setting of relevant properties of the junction points for particular application cases. With this, for example, only connections to junction points with these relevant properties can be taken into account, i.e., further traced. In this way, following a pass, a graph is obtained that contains only the desired structures and thus, under certain circumstances, is significantly smaller than the overall graph. In this way, a further processing of the extracted information items is substantially more efficient.

The symbol data herein advantageously comprises information that identifies whether connections extending beyond the respective symbol should be traced. In this way, limits can be also placed on the recognition and classification of the nodes, if particular regions of the technical drawing are not relevant for the desired application.

In a further alternative or additional embodiment of the method, the symbol data comprises a second representation of the symbol type, where the second representation comprises a plurality of nodes with respectively associated symbol types and connections to end points associated with the plurality of nodes. In other words, a symbol type can be identified as an assembled symbol, i.e., it is actually assembled from a plurality of also previously defined elementary symbols and connections under these elementary nodes and thus forms a subgraph which corresponds to the aforementioned second representation. The outwardly directed junction points that are not connected within the subgraph herein correspond to the junction points of the higher-level assembled symbol. If, during the classification, a symbol is encountered that is marked as an assembled symbol, it can immediately be replaced by its elementary symbols and connections, if this is desired. At this point, all the other symbol and junction point properties, for example, the previously defined end of the further tracing of connections, are also taken into account at a correspondingly marked symbol, etc.

Advantageously, the junction point data also comprises information that indicates whether the respective junction point for the use of the respective second representation must be associated with an end point. This means that the replacement of an assembled symbol by the corresponding subgraph is linked to the condition that one or more specified junction points must be connected. This enables an automatic error message to the user if this should not be the case.

In a further advantageous embodiment of the method, the junction point data contains information that indicates whether the respective junction point can be duplicated. Depending on the respective use, it can occur that a plurality of connecting lines converge at a junction point of a symbol. In order to represent this logically, the corresponding port can be duplicated, i.e., in the logical representation in the data set, an identical junction point is stored at the respective node, i.e., the existing junction point is duplicated and a respective end point of each of the converging connections is assigned to each of the junction points. If an information item is stored on whether such a duplication is permitted, the possibility exists here again of an automated error message to the user if the marking is not set and such a situation is found.

The method described also enables connections with open ends to be traced and formed. This refers to connections in the technical drawing that have at least one end that does not adjoin a symbol. Such connections typically occur if links are to be made over, for example, multiple pages of technical drawings. This is indicated, for example, by textual descriptions (example: an indication “A/02” is intended to convey that a connection to the identifier “A” on page 02 should be completed). The described step c), specifically identifying the connections, advantageously comprises for this purpose the identification of open lines proceeding from a symbol in the technical drawing, a connector being associated with the open end point of the representing connection in the data set, which is stored in the data set and represents a connection to a connector of a second technical drawing. Connectors are identified based on particular pre-set properties stored in the symbol library. If a connector of this type is found, it is included as a node in the overall graph in the data set. Found items of text information are associated with the connector.

The data set generated by the method is advantageously combined, based on the linking of the connectors, with the second data set representing the second technical drawing situated on the other page. In other words, connections between compatible connectors are (depending on the application) automatically closed (in the graph this means that the connector node is removed and a suitable connection, i.e., edge is inserted into the graph, where the end points of the new connection correspond to the respective end points of the connections linked at the connector). It is herein important that particular text information items can be passed on by the graph to all the junction points for which the information items are relevant (e.g., signal names across particular components and pages).

As already described, some of the junction point data of stored junction points (duplicatability, necessity of the connection on replacement by substructure) enable the recognition of errors in the library both in the association as well as in the technical drawing itself. In general, the fulfillment capability of conditions stored in the symbol data and/or the junction point data is advantageously tested and, in the case of non-fulfillability, an error is recognized. Herein, if required, either the classification of the recognized symbols with the correct symbol types can be improved, e.g., in that the user is requested to check manually, or (if a classification on the basis of previously specified criteria has been allocated a sufficient reliability) in this way an error in the technical drawing itself can also be identified.

It is also an object of the invention to provide a computer program product that can be loaded directly into the internal memory of a computer advantageously, which comprises software code portions with which the method described is performed when the computer program product executes on the computer.

A computer system advantageously comprises a scanner and an internal memory into which a computer program product of this type is loaded.

The advantages achieved with the invention consist particularly therein that through the determination and allocation not only of symbols and lines of a technical drawing, but through the prior definition of junction points in the library symbols and the allocation of the junction points to individual connections, markedly more semantic, interpretable information items are taken into account, which significantly improve the recognition accuracy and also the usage possibilities of the data set generated. Not only mere connections, but also their directions can herein be recognized, specifically independently of how it is handled in documents provided (if determinations are made only from the junction points and the corresponding junction point properties of the associated library symbols). The method also enables connections to be further traced across different pages and, if necessary, to be closed based on recognized connectors.

During the classification, reactions and actions can be performed depending on the properties defined in the symbol library, e.g., ending of the further tracing at particular symbols, replacement of assembled symbols by previously defined elementary symbols and automatic duplication of multiply-connected ports.

The method also enables improved automatic error recognition via the directed edges of the graph stored in the data set and the knowledge of which junction point types are connected, senseless connections can be found (e.g., connections between two incoming junction points). Whether errors of this type arise due to an erroneous recognition or from already faulty documents plays no part herein. In each case, a manual intervention is advisable. The relevant user can thus be informed herewith, with specification of the symbols involved, the document and also the junction points involved.

Junction point properties defined in the symbol library can be checked during classification and processing of the documents and, if necessary, suitable action can be taken. Examples thereof from WO 2013/092654 A1 described in the introduction are checking whether a junction point must be connected and whether a multiply-bound junction point may be duplicated automatically. In case of error, a suitable notification can be passed to the user with precise details of document, symbol and junction point.

Text information which is associated with connectors can be passed automatically by means of the graph which arises, including across a plurality of pages. This capability can be used in the application described in WO 2013/092654 A1 to pass signal names and further information items to remotely situated junction points.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

Exemplary embodiments of the invention will now be described in greater detail making reference to the drawings, in which:

FIG. 1 is a schematic flow diagram of a method for the automated creation of a data set characterizing a technical drawing having symbols and lines connecting the symbols;

FIG. 2 is a schematic representation of a technical drawing;

FIG. 3 is a schematic representation of the technical drawing in a part of the data set;

FIG. 4 is a schematic representation of a symbol library;

FIG. 5 is further refined schematic representation of the technical drawing in a part of the data set;

FIG. 6 is a representation of a symbol type together with its substructure;

FIG. 7 is a representation of the substructure in the symbol library;

FIG. 8 is a representation of a part of two technical drawings with open connections; and,

FIG. 9 is an input screen of the symbol library for storing the symbol data and junction point data.

### DETAILED DESCRIPTION OF THE EXEMPLARY EMBODIMENTS

The same components are provided with the same reference numbers in all the figures.

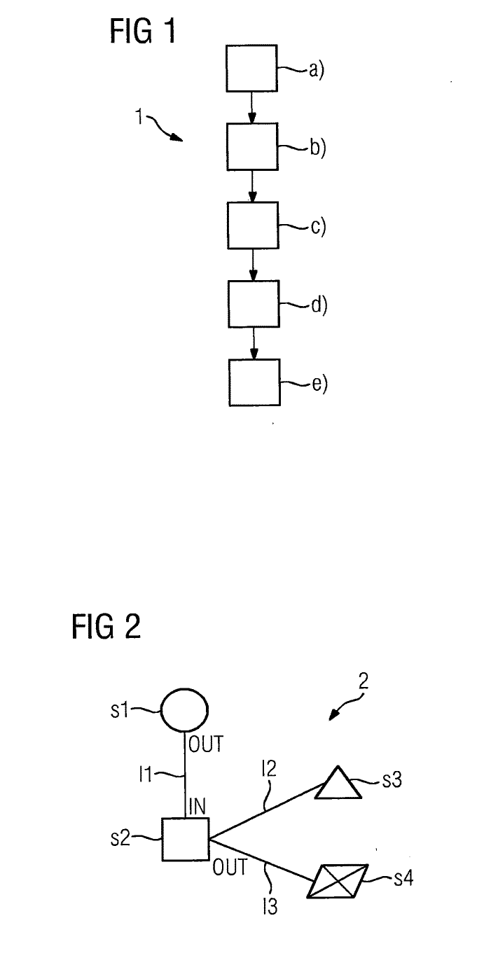

FIG. 1 is a schematic flow diagram of a method 1 for automatically creating a data set characterizing a technical drawing having symbols and lines connecting the symbols. The basis hereof is therefore a technical drawing. A technical drawing is, in general, a document that contains all necessary information items for generation and description of the required functions and properties of a single part, an assembly or a complete product in graphical and written form and serves as part of the technical product documentation. In general, particularly for relatively complex systems, such as whole manufacturing plants, many hundreds and thousands of pages of such technical drawings exist. These are characterized in that they consist of symbols that represent, for example, individual components as well as lines between the symbols which represent operative connections, e.g., a current or data transmission.

All the steps of the method shown in FIG. 1 are performed in a computer system (not shown in detail) which is made suitable to perform the steps. In particular, a computer program is loaded into the memory of the computer system, comprising software code portions which cause the computer system to perform the method.

In step a), firstly, the technical drawing is scanned. This includes all pages of the technical drawing, i.e., a plurality of pages of technical drawings are digitally recorded. For further processing, the scanned image files are vectorized, i.e., in each raster image generated, simple geometric objects are identified during the vectorization. This can occur with common technical variants known to persons skilled in the art, e.g., by edge detection, regions of the same or similar lightness or color, also known as posterization, are determined. The final result is coordinate data of graphic primitives in the technical drawing, i.e., lines, open or closed curves, points, etc.

From the vector graphic, following on from step b), the symbols in the technical drawing are identified, i.e., their number and position. In the data set to be generated that is to represent the technical drawing, representative nodes are now stored for each symbol. A data subset therefore forms for each symbol on the respective page.

In step c), which can also occur simultaneously with step b), lines connecting, respectively, at least two symbols in the technical drawing are identified and connections representing each line are stored in the data set. Herein, at least two end points are associated with each connection and one of the nodes that represent the symbols connected by the respective line is associated with each end point.

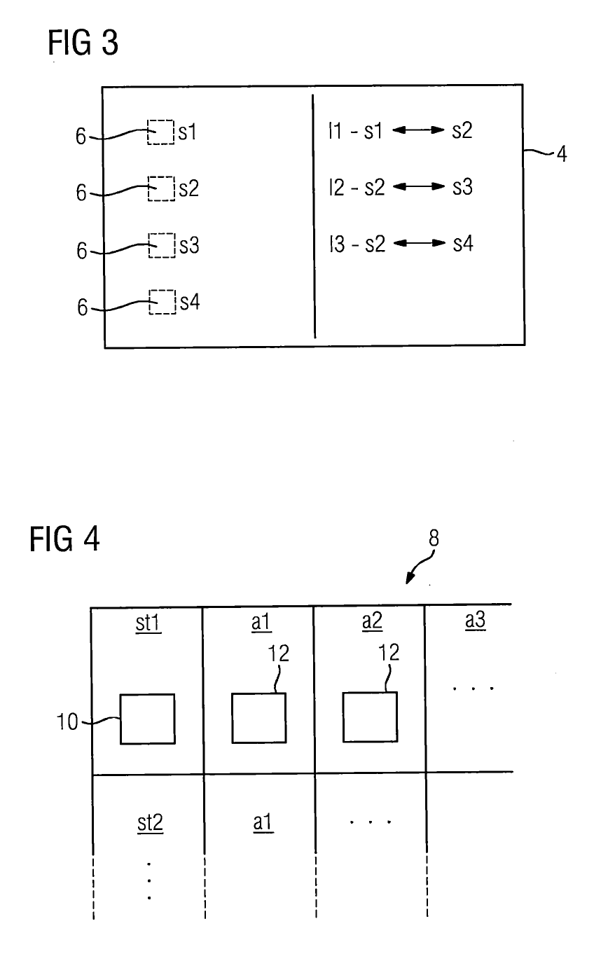

The steps a), b) and c) will now be described by reference to FIGS. 2 and 3. FIG. 2 shows a schematic abstract simplified image of a technical drawing 2. It comprises in the upper region, a symbol s1 represented as a circle, a symbol s2 in the lower region represented as a square and two symbols s3 and 84 in the right-hand region represented as a triangle and a crossed parallelogram, respectively.

The symbol s1 has a connection at the underside thereof identified with “OUT”, and the symbol s2 has a connection at the upper side thereof identified with “IN”. The connections are linked by the line 11. The symbol s2 has a further connection at the right-hand side thereof identified with “OUT”. Starting from this connection, a line 12 leads to a connection at the left-hand side of the symbol s3 and a further line 13 leads to a connection at the left-hand side of the symbol s4. The symbol 82 has a further unidentified connection at its left-hand side that is not connected.

It is an object of the method essentially to automatically extract the above-described properties of the technical drawing 2 and possibly further contextual information items from the technical drawing 2 itself.

FIG. 3 shows the data set 4 as it exists following steps a), b) and c). The four recognized symbols s1, s2, s3 and s4 together with their graphical information items 6, i.e., their graphical representation, are stored in “bounding boxes” in vectorized form. The data set further contains information items that the three lines 11, 12 and 13 were recognized and respectively connect the symbols s1-s2, s2-s3 or s2-s4. In the mathematical sense, these information items correspond effectively to an undirected graph.

The information so far extracted does not in any way correspond to the complete information extracted from the technical drawing 2 and is suitable for further use to only a limited extent. Therefore, making reference again to FIG. 1, further steps d) and e) are performed in which the connections are traced and the symbols classified.

In step d), a symbol library 8 is prepared, as shown partially and schematically in FIG. 4. The symbol library 8 is created specifically for a particular technical drawing 2 or specifically for a particular technical system that is described by the technical drawing 2. It contains symbol types st1, st2, etc. for each symbol possibly occurring in the respective system and represented in a technical drawing. Symbol data 10 is stored for each of these symbol types st1, st2, etc., such as a graphical representation of the symbol for comparison with the graphical information 6 from the scanned, vectorized representation of the symbols. It is possible with just these information items to identify more precisely the nodes of the aforementioned undirected graph in the data set 4.

However, the method is also to be more error-proof, to detect more information items from the technical drawing 2 and herein possibly also to recognize errors in the technical drawing 2 itself. For this purpose, the symbol library 8 is expanded with a plurality of information items. Initially, for each symbol type st1, st2, etc., junction points a1, a2, a3, etc. are defined. This means that for each symbol type st1, st2, etc., how many junction points a1, a2, a3, etc. it has is stored. For each of the junction points a1, a2, a3, etc., junction point data 12 is stored which contains further information items regarding the respective junction point a1, a2, a3, etc.

Initially, information items for the identification of the respective junction point a1, a2, a3, etc. are stored in the junction point data 12. For example, it can be stored that symbol type st2 has three junction points st2-a1, st2-a2 and st2-a3. st2-a1 is herein centrally arranged on the upper edge of the bounding box. Or, however, st2-a1 is always identified by means of a particular text at a particular separation and in a particular direction starting from its position, such as the text “IN” and “OUT” shown in FIG. 1. Furthermore, for each junction point a1, a2, a3, a junction point type can be stored, for example, “incoming”, “outgoing”, “negation”, or “link only with arrow” For the junction point types, information items regarding which junction point types may be connected by a connection are stored in the symbol library, such as if an “incoming” junction type must always be connected via a line to an “outgoing” junction point.

It can also be stored in the junction point data 12 whether a junction point a1, a2, a3 may be duplicated if a plurality of connections to it exist or whether this indicates an error. This can also be linked to further conditions. A junction point a1, a2, a3 can also be marked to the effect that it must necessarily be connected, particular partial structures proceeding therefrom are to be recognized or what significance it has in a format to be generated from the known documents.

With the junction point data 12 stored specifically for junction points a1, a2, a3, step e) can now be performed in relation to FIG. 1. Herein, in each case a symbol type st1, st2, etc. from the symbol library 8 is assigned to each node in the graph and the respective information items are stored in the data set 4. Furthermore, the junction point data 12 and the symbol data 10 are evaluated to the effect that each recognized junction point a1, a2, a3, etc. for each symbol 81, 92, s3, s4 with each respectively associated symbol type st1, st2, etc. is associated with a respective end point of a connection, provided it is connected. This takes place through successive tracing of the connections between the symbols s1, s2, s3, s4.

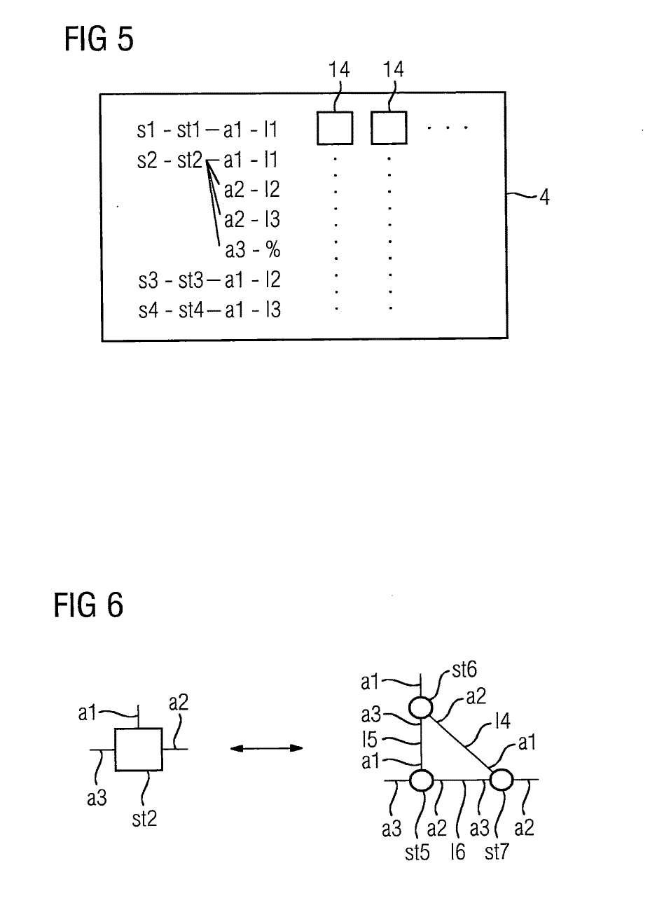

The data set formed is shown by way of example in FIG. 5. Here again, the symbols s1, s2, s3, s4 are listed, but with a plurality of further information items. Apart from the association with the respective symbol types st1, st2, st3, st4, each junction point a1, a2, a3, etc. taken from the symbol library relating to each symbol type st1, st2, st3, st4 for the symbols s1, s2, s3, s4 is also identified and associated with an end point of a line 11, 12, 13. By way of example, this will now be described for the symbol s2: it is associated with the symbol type st2 which, according to the symbol library 8, has three connections st2-a1, st2-a2, st2-a3. Herein, st2-a1 is identified in the symbol library 8 as “incoming” and st2-a2 is identified as “outgoing”, where this information is stored in further data 14 in the data set 4. The graph that arises therefore also receives one direction. It is further stored for junction point st2-a2 that it can be duplicated, which is also the case in the technical drawing 2, because two lines 12, 13 are connected to this connection.

In the data set 4, it is stored that for the symbol s2, the connection st2-a1 with line 11, the first duplicate of the connection st2-a1 with line 12, the second duplicate of the connection st2-a1 with line 13 and the connection st2-a3 is free. In addition, in the data 14, any desired further information items extracted from the symbol data 10 and the junction point data 12 which can be used during the further processing are stored. Particular parameters can also be pre-set during the evaluation in step d) and e), so that for example, particular junction points a1, a2, a3, etc. are to be ignored if only one portion of the technical drawing 2 is to be detected for a particular application purpose. Herein, it can also be stored in the symbol data 10 that connections beyond particular symbols st1, st2, etc. are no longer to be traced.

In general, the symbol data 10 is also significantly extended in the embodiment of the method 1 shown. For example, for particular symbol types st1, st2, etc., where this is required or desired, a disassembly into subsymbol types can be stored. An example of this is a unit in a circuit diagram that consists, in turn, of a plurality of components connected to one another. For some uses, it might be sufficient to show just the unit itself with its junction points, whereas for other uses, the inner structure of the unit is also relevant. For this purpose, the substructure can be stored in the symbol data 10.

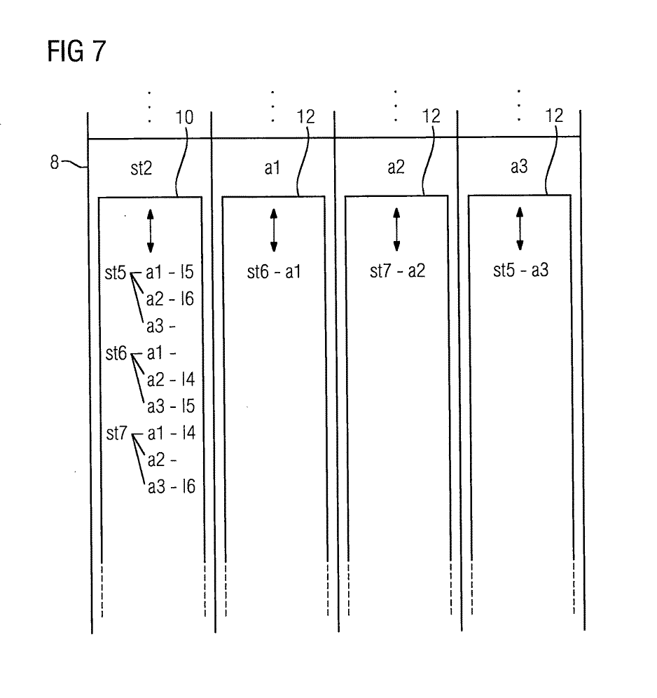

This is shown in FIGS. 6 and 7. FIG. 6 shows the symbol type st2 with its three junction points a1, a2 and a3 in the left-hand image portion and in the right-hand image portion, a second representation 16 of the symbol type st2 in the form of its substructure, consisting of the three symbol types st5, st6 and st7. The symbol types st5, st6 and st7 each have three junction points a1, a2, a3 and are connected to one another by the lines 14, 15, 16. what remains undecided herein is only the junction point st6-a1 that corresponds to the connection point st2-a1 in the higher-level structure, the connection point st7-a2, which corresponds to the junction point st2-a2 in the higher-level structure and the junction point st5-a3 which corresponds to the junction point st2-a3 in the higher-level structure. Thus, both the substructure is known and also the correspondence of the outer junction points a1, a2, a3 of the higher-level symbol type st2 to the outer junction points of the substructure.

The substructure is in the same form as the main structure described in the symbol data 10 in the symbol library 8, as shown in FIG. 7. This means that, firstly, all the symbol types st5, st6, st7 of the substructure are stored, as also are all the junction points a1, a2, a3 of each symbol type st5, st6, st7 of the substructure. The junction points a1, a2, a3 already connected within the substructure by connections 14, 15, 16 are also identified and stored, as described above. Furthermore, it is stored in the junction point data 12 for each connection point a1, a2, a3 of the symbol type st2, as described above, which junction points a1, a2, a3 of which symbol type st5, st6, st7 of the substructure correspond to them.

This storage in the symbol library 8 makes it possible during the creation of the data set 4 to replace such symbol types, for which a second representation 16 is stored, with the substructure according to a suitable pre-setting or automatically. Criteria for this can also be stored in the junction point data 12, for example, that a replacement of this type by the second representation 16 only occurs if a particular junction point a1, a2, a3 of the higher-level symbol type is connected in the scanned document.

A further advantage of the method 1 described above is also that connections can be traced across a plurality of pages. This takes place in real technical drawings, for example, via textual descriptions (example: an indication “A/02” is intended to convey that a link to the identifier “A” on page 02 should be completed).

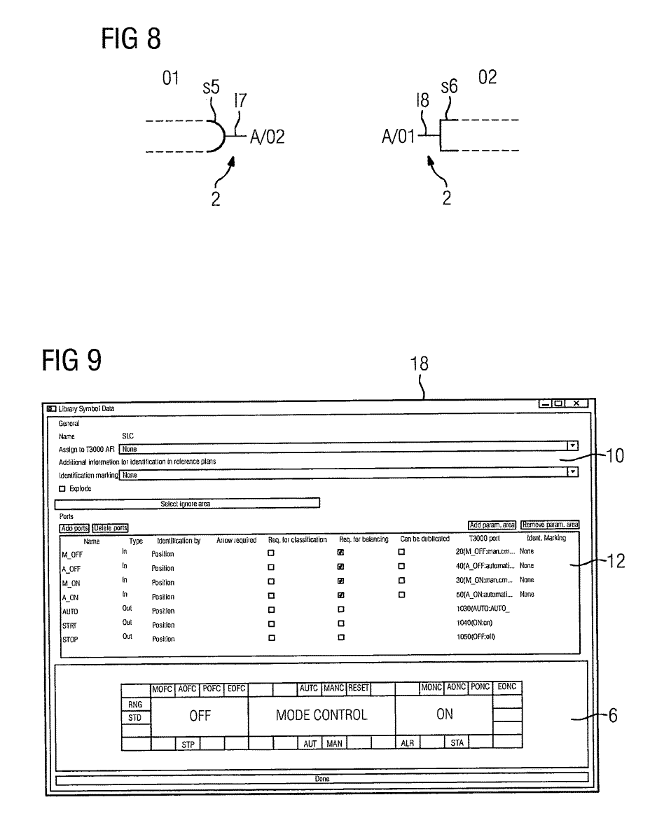

For this purpose, in the above-described step c), open lines emerging from a symbol are also identified in the technical drawing. FIG. 8 shows such a situation. In the left-hand image half, a portion of a first technical drawing 2, specifically page “01” is shown. In the right-hand image half, a portion of a second technical drawing 2, specifically page “02” is shown. Page “01” comprises a symbol s5 with a connected line 17. At the open end of the line 17, an identifier “A/02” is stored. The corresponding end point of the line 17 is thus associated with a connector K1 and with the connector K1, the image data of the identifier is stored. This occurs in the context of step c) and is not shown separately.

The same occurs for page “02”. This page comprises a symbol s6 with a connected line 18. At the open end of the line 18, an identifier “A/01” is stored. Just as for page “01”, the corresponding end point of the line 18 is associated with a connector K2 and with the connector K2, the image data of the identifier is stored.

Once both drawings are scanned in and recorded, the connectors K1, K2 can now be allocated. The identifiers are to be associated with one another in the technical drawings 2, which can now be performed automatically in the digital image of the data set 4: the identifiers are herein automatically recognized so that the connectors K1 and K2 can be associated with one another. With the association of K1 to K2, the lines 17, 18 can be bound into one line and the respective other end points of the lines 17, 18 form the end points of the newly arising line and its associations. Thus, a data set 4 forms which comprises both drawings 2.

The tracing of the open connections, as described, can be implemented efficiently as a stack structure. During the vectorization or text recognition, a type of table of contents is herein created, from which it is apparent which (unambiguous) identifiers belong to which page. In this way, when tracing connectors, the relevant page is opened directly and investigated. In the event that an identifier is not or is falsely recognized, all the pages are naturally investigated nonetheless.

The system further enables an automatic recognition of errors in the technical drawings 2. During the method 1 described, during the association, it is always checked whether a junction point must be connected and whether a multiple-bound junction point may be duplicated automatically. It is further checked whether the rules regarding the linking are adhered to, i.e., it is checked whether, for example, two junction points marked as “incoming” are falsely linked to one another. In case of error, a suitable notification can be output with precise details of document, symbol and junction point to the user who carries out a manual check and correction.

The method 1 has so far been described making reference to a simplified schematic exemplary embodiment. FIG. 9 shows a component of a further exemplary embodiment for use in the T3000 control system developed by the applicant for power generating plants. The “Siemens Power and Process Automation System T3000” (SPPA-T3000) was conceived to fulfill all the functions of power station automation: turbine regulation, boiler regulation including boiler protection, subsidiary and auxiliary systems and the integration of systems from other suppliers, such as gasification plants in the context of IGCC (Integrated Gasification Combined Cycle) applications.

FIG. 9 shows an actual input screen 18 of the symbol library 8 for storage of the symbol data 10 and junction point data 12. This is displayed in a known graphical user interface on a computer system in order to store symbol types in the symbol library 8.

The input screen 18 shows in the lower region the graphical information 6, i.e., an actual image of the symbol type together with its junction points and their position, which are used as described for allocating the symbol types to symbols.

In the upper region, the input screen 18 shows possibilities for the input of symbol data 10. The list shown enables the input of a name for the symbol type and the automatic allocation to a named API (automation function instance) which represents a particular function block in the SPPA-T3000. Furthermore, particular identification markings can be stored and an automatic replacement by a substructure can be instigated (“Explode macro”).

Finally, in the middle region are possibilities for storing junction point data which takes place in the form of a table. There are switching surfaces for adding or removing junction points, each representing a row of the table. Stored in the columns are the different types of junction point data, firstly a junction point name and a junction point type (here: “IN”=“incoming” or “OUT”=“outgoing”).

Also, the type of the identification is stored. In the example of FIG. 9, all the junction points are identified by their position which can be defined, for example, by clicking in the lower image. Furthermore, particular requirements can be registered through tick fields, specifically the requirement for a directed connection, the requirement for the connection per se and the possibility of data-side duplication. Finally, particular information items for identification within the SPPA-T3000 system and further identification markings can be stored.

With the input screen 18 shown, the creation of a symbol library 8 for use in the SPPA-T3000 system is possible relatively easily, by which the above-described method 1 for the automated detection of technical drawings 2 can be applied rapidly.

While there have been shown, described and pointed out fundamental novel features of the invention as applied to a preferred embodiment thereof, it will be understood that various omissions and substitutions and changes in the form and details of the methods described and the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1.-14. (canceled)

15. A method performed in a computer system for automatically creating a data set characterizing a technical drawing, having symbols and lines connecting the symbols, from the technical drawing, the method comprising:
a) scanning the technical drawing;
b) identifying the symbols in the scanned technical drawing and storing nodes representing each symbol in the data set;
c) identifying lines, each connecting at least two symbols in the scanned technical drawing and storing connections representing each line in the data set, at least two end points being associated with each connection and one node of the stored nodes which represent the symbols connected by the respective line being associated with each end point;
d) providing a symbol library having a plurality of symbol types and symbol data associated with each symbol type; and
e) associating exactly one symbol type from the symbol library with each node at least based on the symbol data and storing the associated symbol type for a respective node in the data set;
wherein step d) comprises storing a plurality of junction points with junction point data associated with each junction point for a number of the symbol types in the symbol library; and
wherein step e) comprises associating precisely one respective junction point with a plurality of the end points at least based on the junction point data and storage of a respective associated junction point for a respective end point in the data set.

16. The method as claimed in claim 15, wherein the junction point data comprises a junction point type, wherein it is stored, for each junction point type, with which junction point types the respective junction point type can form common end points of a connection.

17. The method as claimed in claim 16, wherein identification properties are stored for each junction point type.

18. The method as claimed in claim 15, wherein the junction point data contains information which indicates whether the respective junction point must be associated with an end point.

19. The method as claimed in claim 15, wherein step e) occurs serially, starting from a connection, by tracing further connections adjoining the node of an end point of the connection.

20. The method as claimed in claim 19, wherein the symbol data herein advantageously comprises information which identifies whether connections extending beyond the respective symbol should be traced.

21. The method as claimed in claim 15, wherein the symbol data comprises a second representation of the symbol type, the second representation comprising a plurality of nodes with respectively associated symbol types and connections to end points associated with the plurality of nodes.

22. The method as claimed in claim 21, wherein the junction point data comprises information which indicates whether the respective junction point must be associated with an end point for use of the respective second representation.

23. The method as claimed in claim 15, wherein the junction point data contains information which indicates whether the respective junction point can be duplicated.

24. The method as claimed in claim 15, wherein step c) comprises identifying open lines proceeding from a symbol in the scanned technical drawing, a connector being associated with an open end point of a representing connection and being stored in the data set, which represents a connection to a connector of a second technical drawing.

25. The method as claimed in claim 24, wherein the data set is combined with a data set representing the second technical drawing based on linking of the connectors.

26. The method as claimed in claim 15, wherein a fulfillment capability of conditions stored in at least one of the symbol data and the junction point data is tested and, in cases of non-fulfill ability, an error is recognized.

27. A non-transitory computer program product which is loadable directly into an internal memory of a computer and which comprises software code portions, which when executed on a computer causes, automatic creation of a data set characterizing a technical drawing, having symbols and lines connecting the symbols, from the technical drawing, the software code portions comprising:
a) program code instructions for scanning the technical drawing;
b) program code instructions for identifying the symbols in the scanned technical drawing and storing nodes representing each symbol in the data set;
c) program code instructions for identifying lines, each connecting at least two symbols in the scanned technical drawing and storing connections representing each line in the data set, at least two end points being associated with each connection and one node of the stored nodes which represent the symbols connected by the respective line being associated with each end point;
d) program code instructions for providing a symbol library having a plurality of symbol types and symbol data associated with each symbol type; and
e) program code instructions for associating exactly one symbol type from the symbol library with each node at least based on the symbol data and storing the associated symbol type for a respective node in the data set;
wherein step d) comprises storing a plurality of junction points with junction point data associated with each junction point for a number of the symbol types in the symbol library; and
wherein step e) comprises associating precisely one respective junction point with a plurality of the end points at least based on the junction point data and storage of a respective associated junction point for a respective end point in the data set.

28. A computer system comprising a scanner and an internal memory into which the non-transitory computer program product as claimed in claim 27 is loaded.
